(19) United States
(12) Patent Application Publication
(10) Pub. No.: US 2008/0044272 A1
(43) Pub. Date: Feb. 21, 2008

(54) Utilizing alternative energy

(76) Inventor: Edward Robert Segal, White Plains, NY (US)

Correspondence Address: Edward Segal, 100 Fisher Ave P1990, White Plains, NY, 10602-1990, US

(21) Appl. No.: 11/504,418

(22) Filed: Aug. 16, 2006

(51) Int. Cl. F03B 15/06

(52) U.S. Cl. 415/4.1

(57) ABSTRACT

A device, device(s), method and/or apparatus that can utilize 1 or more/various forms of inputs for energy

This may be done to perform or enhance various functions or purposes or to provide additional capability such as power, energy, storage, etc.

A device, device(s), method and/or apparatus that can utilize 1 or more/various forms of inputs for energy. This may be done to perform or enhance various functions or purposes or to provide additional capability such as power, energy, storage, etc.

### BACKGROUND OF INVENTION

There are many functions or physical devices that can be made new, novel or improved on by utilizing multiple forms of energy. One set of examples of this relate to utilizing mass, motion, fluids, etc. Another set of examples of these devices and methods relate to the field of power, backup, source, alternate, energy, etc.

### SUMMARY OF INVENTION

The invention utilizes one or more sources or forms of energy to provide, generate, produce and/or store power.

### DESCRIPTION OF PREFERRED EMBODIMENT

Various energy sources, or forms can be used to provide, generate, produce, or store power. One such application is utilizing fluids (some examples include wind, rain, water, storm drains, gutter, drain, outflow, etc.) It is beneficial to have a device that may use these as input or be moved or powered by these. For one subexample a form of channeler, or director, may be utilized to redirect some of the inputs above to a device that can utilize it to produce, create, supplement or store energy. Another subexample may have a form of kite or sail (straight, curved or various other shapes) channeling towards a device. It may be specially formed (may be mobile, movable, flexible) at one or more locations to direct this towards the device. (It may be movable, and/or have members whose direction can be changed). Another application is using rotation to drive a device (One subexample is utilizing fluid(s)) For example, these could be used to power a piston, generator, mill, turbine, or various other forms of devices. These may take various forms. (For 1 example/devices that rotate such as windmills, water wheels, or garden sprinklers, whose rotation may be utilized) This may also be (possibly flexible) member(s) or attached to the above which may be movable and may be used to channel, redirect, or utilize the primary, secondary, tertiary, etc. force, or any resulting motion. Another example is using natural, manmade, channeled or other fresh, waste, or other water or fluid(s) sources flowing from various locations including tap water, hydrants, drains, gutters, sewers, etc. The above are only representative descriptions of some possible applications of these embodiments and concepts. Various other implementations applications, and variations of this invention are also possible. These are also intended be included.

What is claimed is:

1. A device, devices, or components that can utilize one or more, or various forms of input to generate or store energy.

2. A device (and/or member placed near) that can utilize fluid(s) (such as wind, water, rain, gutter, fresh or waste water, sewage, outflow, etc) to produce or store energy

3. A device or member as in claim 2, (such as a windmill, water wheel, sail like, kite like, parachute like, parasail like or other device,) that channels captures, utilizes, fluid(s) (such as wind, water, rain, gutter, sewer, outflow, etc) to produce or store energy

4. A device as in claim 2, with hole(s) or space(s), channel (s), indent(s), groove(s), etc. to move, channel, or direct, fluid to produce energy or to a device that can.

5. A device as in claim 1, to move, channel, direct, etc. one form of motion, energy, etc. to produce energy

6. A device as in claim 1, that may use fiber, glass, plastic, or waveguide(s), etc to move, channel, direct, etc. one form of motion, energy, etc. to produce energy (possibly in various or a different form including light, heat, etc.)

7. A device as in claim 2, with a plate (or (semi) rigid material(s) and/or groove(s) that or utilizes or channels input to produce energy and/or directs it towards a device that can generate energy.

8. The device of claim 2 where there are somewhat cylindrical or tunnel, or windmill or wheel shaped, or surface areas to channel or utilize inputs, energy, etc.

9. A device as in claim 2, or similar device which may be placed in front of, near, below, or above a source of fluid, faucet, sink, drain, etc. that can produce one or more forms or energy

10. A plate as in claim 1 that is depressed producing energy.

11. A rotating device as in claim 2 that can produce energy

12. A device as in claim 2 such as a wheel, turnstile, etc. whose rotation can produce energy.

13. A device as in claim 3 that is attached by a member (which may be rigid, semi-rigid, or flexible, such as rope(s), cable(s) or string(s) produce energy or connect or channel it to a device that can.

14. A device as in claim 3 that is attached by a member (which may be rigid, semi-rigid, or flexible, such as rope(s), cable(s) or string(s)) that has the ability to produce energy or connect or channel it to a device that can, by such means as moving a rotating member, piston, rolling object, cylinder, sphere, wheel, etc.

15. A device as in claim 3 that is attached by a member (which may be rigid, semi-rigid, or flexible, such as rope(s), cable(s) or string(s)) that can produce energy or connect or channel it to a device that can, by such means as moving a rotating member, piston, rolling object, cylinder, sphere, wheel, etc., and which can take input (or energy, or force, fluid etc.) from many, multiple, all directions.

16. A device as in claim 3 that is attached by a member (which may be rigid, semi-rigid, or flexible, such as rope(s), cable(s) or string(s)) that can produce energy or connect or channel it to a device that can, by means including moving a rotating member, piston, rolling object, cylinder, sphere, wheel, etc., and which can take input (or energy, or force, fluid etc.) from many, multiple, all directions, by means including running cable(s), rope(s), etc. through a device to take force from all directions, or redirect force.

17. A device as in claim 3 that is attached by a member (which may be rigid, semi-rigid, or flexible, such as rope(s), cable(s) or string(s)) that can produce energy or connect or channel it to a device that can, by such means as moving a rotating member, piston, rolling object, cylinder, sphere, wheel, etc., and which can take input (or energy, or force, fluid etc.) from many, multiple, all directions, by means including running cable(s), rope(s), etc. through a device to take force from all directions, or redirect force, such as a ring, flange, pivoting member, etc.

18. A device as in claim 3 that utilizes spinning, turning, or rotation due to fluid(s).

19. A device as in claim 3 that utilizes spinning, turning, or rotation due to fluid(s) similar to a rotating garden sprinkler, water wheel, wind mill, etc., that can also take input from other fluids such as water.

20. A device as in claim 3 that utilizes spinning, turning, or rotation due to fluid(s) similar to a rotating garden sprinkler, water wheel, wind mill, etc., that can also take input from other fluids (including but not limited to) water, wind, etc. and which may in turn utilize, couple, redirect, etc. this force by connecting it via additional member(s) such as affixing one or more member(s) to the device which may be moving, rotating, etc.
